(19) United States
(12) Patent Application Publication
(10) Pub. No.: US 2025/0153160 A1
(43) Pub. Date: May 15, 2025

(54) PROCESS AND APPARATUS FOR REGENERATING CATALYST

(71) Applicant: UOP LLC, Des Plaines, IL (US)

(72) Inventors: Mohammad-Reza Mostofi-Ashtiani, Naperville, IL (US); Sathit Kulprathipanja, Schaumburg, IL (US); Michael S. Sandacz, Glen Ellyn, IL (US)

(21) Appl. No.: 18/508,944

(22) Filed: Nov. 14, 2023

(51) Int. Cl. B01J 38/02

(52) U.S. Cl. CPC B01J 38/02

(57) ABSTRACT

A catalyst regenerator vessel and a process for combusting carbonaceous deposits from catalyst is disclosed. The catalyst regenerator vessel comprises a combustion gas distributor in fluid communication with a combustion gas line for introducing a combustion gas to the vessel, a catalyst pipe, and a catalyst distributor in fluid communication with the catalyst pipe. The catalyst distributor comprises a header and a nozzle, the header and the nozzle are in fluid communication with the catalyst pipe for distributing coked catalyst to the vessel. The header comprises a header and a plurality of nozzles including an angular nozzle projecting at an angle to a longitudinal axis of the header. The process comprises delivering coked catalyst from a catalyst pipe to the catalyst distributor wherein the catalyst distributor discharges the coked catalyst from at least two sides of the catalyst pipe into the regenerator vessel.

### FIELD

The field is related to distribution of catalyst in a catalyst regenerator vessel. The field may particularly relate to a distributor for distributing catalyst in a catalyst regenerator vessel.

### BACKGROUND

Fluid catalytic cracking (FCC) is a hydrocarbon conversion process accomplished by contacting hydrocarbons in a fluidized reaction zone with a catalyst composed of finely divided particulate material. The reaction in catalytic cracking, as opposed to hydrocracking, is carried out in the absence of substantially added hydrogen or the consumption of hydrogen. As the cracking reaction proceeds substantial amounts of highly carbonaceous material referred to as coke is deposited on the catalyst. A high temperature regeneration operation within a regenerator zone combusts coke from the catalyst. Coke-containing catalyst, referred to herein as coked catalyst, is continually removed from the reaction zone and replaced by essentially coke-free catalyst from the regeneration zone. Fluidization of the catalyst particles by various gaseous streams allows the transport of catalyst between the reaction zone and regeneration zone.

A common objective of these configurations is maximizing product yield from the reactor while minimizing operating and equipment costs. Optimization of feedstock conversion ordinarily requires essentially complete removal of coke from the catalyst. This essentially complete removal of coke from catalyst is often referred to as complete regeneration. Complete regeneration produces a catalyst having less than 0.1 and preferably less than 0.05 wt-% coke. In order to obtain complete regeneration, the catalyst has to be in contact with oxygen for sufficient residence time to permit thorough combustion.

Conventional regenerators typically include a vessel having a coked catalyst inlet, a regenerated catalyst outlet and a combustion gas distributor for supplying air or other oxygen containing gas to the bed of catalyst that resides in the vessel. Cyclone separators remove catalyst entrained in the flue gas before the gas exits the regenerator vessel.

There are several types of catalyst regenerators in use today. The conventional bubbling bed regenerator typically has just one chamber in which air is bubbled through a dense catalyst bed. Coked catalyst is added and regenerated catalyst is withdrawn from the same dense catalyst bed. Relatively little catalyst is entrained in the combustion gas exiting the dense bed. Two-stage bubbling beds have two chambers. Coked catalyst is added to a dense bed in a first chamber and is partially regenerated with air. The partially regenerated catalyst is transported to a dense bed in a second chamber and completely regenerated with air. The completely regenerated catalyst is withdrawn from the second chamber.

Complete catalyst regeneration can be performed in a dilute phase fast fluidized combustion regenerator. Coked catalyst is added to a lower chamber and is transported upwardly by air under fast fluidized flow conditions while completely regenerating the catalyst. The regenerated catalyst is separated from the flue gas by a primary separator upon entering into an upper chamber from which regenerated catalyst and flue gas is removed.

Oxides of nitrogen (NOₓ) are usually present in regenerator flue gases but should be minimized because of environmental concerns. Production of NOₓ is undesirable because it reacts with volatile organic chemicals and sunlight to form ozone. Regulated NOₓ emissions generally include nitric oxide (NO) and nitrogen dioxide (NO₂), but the FCC process can also produce NOₓ. In an FCC regenerator, NOₓ is produced almost entirely by oxidation of nitrogen compounds originating in the FCC feedstock and accumulating in the coked catalyst. At FCC regenerator operating conditions, there is negligible NOₓ production associated with oxidation of N₂ from the combustion air. Low excess air in the regenerator is often used by refiners to keep NOₓ emissions low.

After burn is a phenomenon that occurs when hot flue gas that has been separated from regenerated catalyst contains carbon monoxide that combusts to carbon dioxide. The catalyst that serves as a heat sink is removed from the flue gas and can no longer absorb the heat thus subjecting surrounding equipment to higher temperatures and perhaps creating an atmosphere conducive to the generation of nitrous oxides. Incomplete combustion to carbon dioxide can result from poor fluidization or aeration of the coked catalyst in the regenerator vessel or poor distribution of coked catalyst into the regenerator vessel.

To avoid after burn, many refiners have carbon monoxide promoter (CO promoter) metal such as costly platinum added to the FCC catalyst to promote the complete combustion to carbon dioxide before separation of the flue gas from the catalyst at the low excess oxygen required to control NOₓ at low levels. While low excess oxygen reduces NOₓ, the simultaneous use of CO promoter often needed for after burn control can more than offset the advantage of low excess oxygen. The CO promoter decreases CO emissions but increases NOₓ emissions in the regenerator flue gas.

On the other hand, many refiners use high levels of CO promoter and high levels of excess oxygen to accelerate combustion and reduce afterburning in the regenerator, especially when operating at high throughputs. These practices may increase NOₓ by up to 10-fold from the 10-30 ppm possible when no platinum CO promoter is used, and excess oxygen is controlled below 0.5 vol %.

Improved methods are sought for preventing after burn and generation of nitrous oxides. Thorough mixing of catalyst and combustion gas in a regenerator promotes more uniform temperatures and catalyst activity fostering more efficient combustion of coke from catalyst.

### BRIEF SUMMARY

An apparatus and a process for combusting carbonaceous deposits from catalyst is disclosed. The apparatus and the process comprise a catalyst distributor in fluid communication with a spent catalyst pipe. The catalyst distributor of the present disclosure comprises at least two openings in the catalyst pipe and a header in communication with one of the openings. An angular nozzle projects at an angle to a longitudinal axis of the header is provided for distributing catalyst for superior performance.

The disclosed catalyst distributor spreads catalyst out in the catalyst bed of the regenerator evenly in the bed. The disclosed catalyst distributor provides a more uniform spent catalyst distribution and temperatures in the dense bed to promote a more uniform exposure of coked catalyst to oxygen resulting in higher regeneration efficiency. The regeneration is also more predictable and thus controllable to complete combustion to carbon dioxide without the need for a CO promoter to prevent after burn. Without after burn and CO promoter, less nitrous oxide is generated in the flue gas.

### BRIEF DESCRIPTION OF THE DRAWINGS

FIG. 1 is a schematic, elevational view of an FCC unit incorporating the present disclosure.

FIG. 2 is a plan view of the regenerator vessel of FIG. 1 showing an exemplary embodiment of the catalyst distributor of the present disclosure.

FIG. 3 is an enlarged partial side view of an exemplary embodiment of the catalyst distributor of the present disclosure.

FIG. 4 is a plan view of the regenerator vessel showing multiple catalyst distributors inside the regenerator vessel in accordance with another exemplary embodiment of the present disclosure.

FIG. 5 is an enlarged partial side view of another exemplary embodiment of the catalyst distributor of the present disclosure.

FIG. 6 is a schematic, elevational view of an alternative FCC unit incorporating another embodiment of catalyst distributor of the present disclosure.

FIG. 7 is a plan view of the regenerator vessel of FIG. 6 showing another exemplary embodiment of the catalyst distributor of the present disclosure.

### DEFINITIONS

The term “communication” means that fluid flow is operatively permitted between enumerated components, which may be characterized as “fluid communication”.

The term “downstream communication” means that at least a portion of fluid flowing to the subject in downstream communication may operatively flow from the object with which it fluidly communicates.

The term “upstream communication” means that at least a portion of the fluid flowing from the subject in upstream communication may operatively flow to the object with which it fluidly communicates.

The term “direct communication” or “directly” means that fluid flow from the upstream component enters the downstream component without passing through any other intervening vessel.

The term “column” means a distillation column or columns for separating one or more components of different volatilities. Unless otherwise indicated, each column includes a condenser on an overhead of the column to condense and reflux a portion of an overhead stream back to the top of the column and a reboiler at a bottom of the column to vaporize and send a portion of a bottoms stream back to the bottom of the column. Feeds to the columns may be preheated. The top pressure is the pressure of the overhead vapor at the vapor outlet of the column. The bottom temperature is the liquid bottom outlet temperature. Overhead lines and bottoms lines refer to the net lines from the column downstream of any reflux or reboil to the column. Stripping columns may omit a reboiler at a bottom of the column and instead provide heating requirements and separation impetus from a fluidized inert media such as steam. Stripping columns typically feed a top tray and take main product from the bottom.

As used herein, the term “zone” can refer to an area including one or more equipment items and/or one or more sub-zones. Equipment items can include one or more reactors or reactor vessels, heaters, exchangers, pipes, pumps, compressors, controllers and columns. Additionally, an equipment item, such as a reactor, dryer, or vessel, can further include one or more zones or sub-zones.

As used herein, the term “predominantly” means an amount of at least generally about 50%, suitably about 70%, and preferably about 90%, by weight, of a compound or class of compounds in a stream.

As used herein, the term “True Boiling Point” (TBP) means a test method for determining the boiling point of a material which corresponds to ASTM D-2892 for the production of a liquefied gas, distillate fractions, and residuum of standardized quality on which analytical data can be obtained, and the determination of yields of the above fractions by both mass and volume from which a graph of temperature versus mass % distilled is produced using fifteen theoretical plates in a column with a 5:1 reflux ratio.

As used herein, the term “T5”, “T10” or “T90” means the temperature at which 5 mass percent, 10 mass percent or 90 mass percent, as the case may be, respectively, of the sample boils using ASTM D-86 or TBP.

As used herein, the term “vacuum gas oil” (VGO) includes hydrocarbons having an initial boiling point above approximately 343° C. (650° F.), with a T10 boiling point temperature using ASTM D1160 of approximately 370° C. (698° F.) and a T90 boiling point temperature using ASTM D1160 of approximately 500° C. (932° F.).

### DETAILED DESCRIPTION

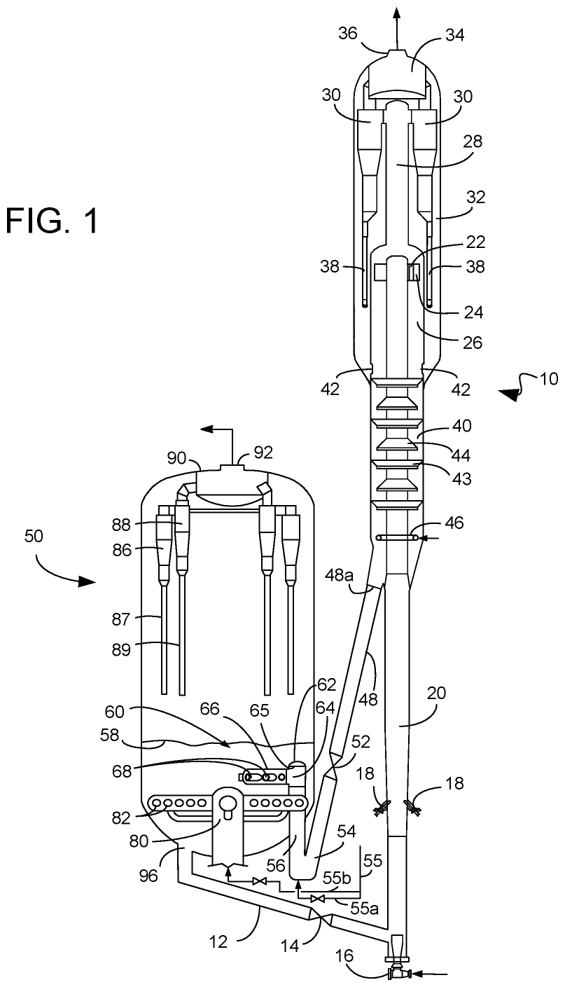

FIG. 1 shows an FCC unit that includes a reactor section 10 and a regenerator vessel 50. A regenerated catalyst conduit 12 transfers regenerated catalyst from the regenerator vessel 50 at a rate regulated by a control valve 14 to a riser 20 of the reactor section 10. A fluidization medium such as steam from a nozzle 16 transports regenerated catalyst upwardly through the riser 20 at a relatively high density until a plurality of feed injection nozzles 18 inject hydrocarbon feed across the flowing stream of catalyst particles. The catalyst contacts the hydrocarbon feed cracking it to produce smaller, cracked hydrocarbon products while depositing coke on the catalyst to produce coked catalyst.

A conventional FCC feedstock or higher boiling hydrocarbon feedstock are suitable feeds. The most common of such conventional feedstocks is a “vacuum gas oil” (VGO). Such a fraction is generally low in coke precursors and heavy metal contamination which can serve to contaminate catalyst. Heavy hydrocarbon feedstocks to which this invention may be applied include heavy bottoms from crude oil, heavy bitumen crude oil, shale oil, tar sand extract, deasphalted residue, products from coal liquefaction, atmospheric and vacuum reduced crudes. Heavy feedstocks for this invention also include mixtures of the above hydrocarbons and the foregoing list is not comprehensive.

The resulting mixture continues upwardly through the riser 20 to a top at which a plurality of disengaging arms 22 tangentially and horizontally discharge the mixture of gas and catalyst from a top of the riser 20 through ports 24 into a disengaging vessel 26 that effects separation of gases from the catalyst. A transport conduit 28 carries the hydrocarbon vapors, including stripped hydrocarbons, stripping media and entrained catalyst to one or more cyclones 30 in a reactor vessel 32 which separates coked catalyst from the hydrocarbon vapor stream. The reactor vessel 32 may at least partially contain the disengaging vessel 26 and the disengaging vessel 26 is considered part of the reactor vessel 32. A collection chamber 34 in the reactor vessel 32 gathers the separated hydrocarbon vapor streams from the cyclones 30 for passage to an outlet nozzle 36 and eventually into a fractionation recovery zone (not shown). Diplegs 38 discharge catalyst from the cyclones 30 into a lower portion of the reactor vessel 32 that eventually passes the catalyst and adsorbed or entrained hydrocarbons into a stripping section 40 of the reactor vessel 32 across ports 42 defined in a wall of the disengaging vessel 26. Catalyst separated in the disengaging vessel 26 passes directly into the stripping section 40. The stripping section 40 contains baffles 43, 44 or other equipment to promote mixing between a stripping gas and the catalyst. The stripping gas enters a lower portion of the stripping section 40 through a conduit to one or more distributors 46. The coked catalyst leaves the stripping section 40 of the reactor vessel 32 through a reactor catalyst conduit 48 and passes to the regenerator vessel 50 at a rate regulated by a control valve 52. The coked catalyst from the reactor vessel 32 usually contains carbon in an amount of from 0.2 to 2 wt %, which is present in the form of coke. Although coke is primarily composed of carbon, it may contain from 3 to 12 wt % hydrogen as well as sulfur and other materials.

The regenerator vessel 50 may be a bubbling bed type of regenerator as shown in FIG. 1. However, other regenerator vessels and other flow conditions may be suitable for the present disclosure. The reactor catalyst conduit 48 with an inlet 48a in downstream communication with the reactor vessel 32 may feed coked catalyst to a catalyst pipe 56 to which air or other oxygen-containing combustion gas may be added through an outlet of a combustion gas line 55 via riser gas line 55a. It is also contemplated that other lift gases may be used to lift the coked catalyst up the catalyst pipe 56. In the embodiment of FIG. 1, the coked catalyst descends the reactor catalyst conduit 48 to a bight which is in upstream communication with the catalyst pipe 56 which may be a riser. In an aspect, the catalyst pipe 56 comprises a spent catalyst pipe or a coked catalyst pipe. The coked catalyst bends around the bight as it is picked up by the lift gas from riser gas line 55a with an outlet in upstream communication with the spent catalyst pipe 56. The coked catalyst then travels up the spent catalyst pipe 56 and enters the regenerator vessel 50. Coked catalyst is delivered to a catalyst distributor 60 through an inlet or opening 64 in the spent catalyst pipe 56 in downstream communication with the catalyst pipe 56 and an outlet from riser gas line 55a for distributing coked catalyst to the regenerator vessel 50.

The spent catalyst pipe 56 may terminate at a top 65. The catalyst pipe 56 may be a portion of the reactor catalyst conduit 48 that is immediately upstream of the catalyst distributor 60 and may be disposed below the catalyst distributor 60. The inlet or opening 64 in the spent catalyst pipe 56 feeds a header 66 which may comprise a longitudinal pipe disposed below the top 65. The header 66 may be in downstream communication with a respective opening 64. Additionally, the header 66 may be perpendicular to the spent catalyst pipe 56 although a slope up or down may be employed for the header. The catalyst distributor 60 comprises at least one and preferably a plurality of nozzles 68 in downstream communication with the header 66 for discharging catalyst into the regenerator vessel 50. The catalyst distributor 60 discharges coked catalyst in an embodiment from under a top surface of a dense catalyst bed 58, and the catalyst distributor 60 is preferably submerged in the bed below the top surface. Additionally, the catalyst distributor 60 is disposed in an eccentric position in the regenerator vessel 50 and radially projects catalyst into the dense catalyst bed 58 therefrom across the entire cross-section of the dense bed. The combustion gas in the spent catalyst pipe 56 assists in the projection of the catalyst into the bed from the catalyst distributor 60 and also provides oxygen for combustion requirements.

In an embodiment, the catalyst distributor 60 may comprise one or more headers 66. In an aspect, the spent catalyst pipe 56 may comprise two or more openings. An opening may feed the catalyst distributor 60 for distributing catalyst into the regenerator vessel 50. A cap 62 may be operatively connected to the top 65 of the spent catalyst pipe 56.

Oxygen-containing combustion gas, typically air, from combustion gas line 55 is primarily delivered to the regenerator vessel 50 by a combustion gas distributor 80 which may be below the catalyst distributor 60. In an embodiment, combustion gas distributor 80 distributes most of the combustion gas to the regenerator vessel 50 and is fed by a distributor gas line 55b from combustion gas line 55 regulated by a control valve. Flutes 82 in the combustion gas distributor 80 are arranged to emit combustion gas equally to the entire cross section of the regenerator vessel 50. The oxygen in the combustion gas contacts the coked catalyst and combusts carbonaceous deposits from the catalyst to regenerate the catalyst and generate flue gas. Catalyst may be entrained with flue gas ascending in the regenerator vessel 50. The catalyst entrained in the flue gas will therefore enter cyclone separators 86, 88 which centripetally separate flue gas from heavier catalyst particles. Catalyst particles will fall down dip legs 87, 89 and enter dense catalyst bed 58 again. Cleaned flue gas will ascend from the cyclone separators 86, 88 through ducts into plenum 90 and discharge through flue gas outlet 92. Regenerated catalyst will depart the dense catalyst bed 58 in the regenerator vessel 50 through a regenerated catalyst outlet 96. Regenerated catalyst conduit 12 in downstream communication with the outlet 96 delivers regenerated catalyst back to the reactor riser 20 at a rate regulated by control valve 14.

Combustion gas such as air may be used to lift coked catalyst up the regenerator riser 54 which may allow regeneration to occur within the regenerator riser. The combustion gas to the regenerator riser 54 may be 10-20 wt % of combustion gas to the regenerator vessel 50. If air is the combustion gas, typically about 13 kg (lbs) to about 15 kg (lbs) of air is required per kilogram (pound) of coke fed on catalyst to the regenerator. The temperature of the regenerator vessel 50 is about 500° C. to about 900° C. and usually about 600° C. to about 750° C. Pressure in the regenerator vessel 50 may range from about 173 kPa (gauge) (25 psig) to about 414 kPa (gauge) (60 psig). The superficial velocity of the combustion gas is typically less than 1.2 m/s (4.2 ft/s) and the density of the dense bed is typically greater than 320 kg/m3 (20 lb/ft3) depending on the characteristics of the catalyst.

In an embodiment, the combustion gas distributor 80 may be located above the catalyst distributor 60 in the regenerator vessel 50. Usually, the combustion gas or air enters the regenerator vessel from a location below the catalyst distributor. In some instances, it may happen that the catalyst distributor size may prove larger, resulting in some portion of the combustion gas bypassing the bed. This would cause afterburn and temperature rise of the internals which may exceed the design temperature. It is important that the combustion gas used in the distributor also act as an oxidizer and the combustion gas bypass is mitigated as much as possible. Applicants found that the catalyst distributor 60 with nozzles 68 may be located below the combustion gas distributor 80. This way the combustion gas rate from each nozzle from the catalyst distributor 60 spends more time, able to cover more area of the bed, and the nozzles may lead to smaller bubbles for better mixing in the catalyst bed before entering the freeboard.

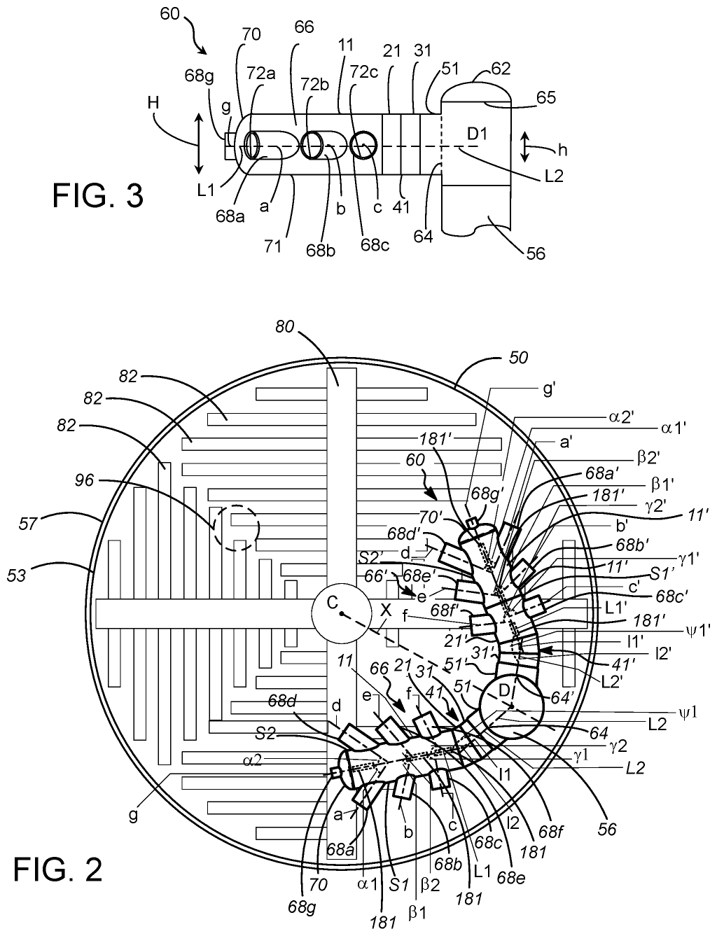

A plan view of an exemplary embodiment of the catalyst distributor 60 inside the regenerator vessel 50 is shown in FIG. 2. In the exemplary embodiment, the catalyst distributor 60 is located inside the regenerator vessel 50 and extends into three quadrants of a cross-section thereof as shown in FIG. 2. The regenerator vessel 50 has a wall 57 with an inner surface 53. As shown in the FIG. 2, the catalyst distributor 60 comprises a first header 66 and a second header 66′. The first header 66 may be in downstream fluid communication with the first opening 64 and the second header 66′ may be in downstream fluid communication with a second opening 64′ in the spent catalyst pipe 56. The catalyst distributor 60 is located above the air distributor 80 and the flutes 82 thereof. The only flutes 82 shown are those not obscured by the catalyst distributor 60 in FIG. 2. In an exemplary embodiment, the first header 66 comprises a first straight section 11 having a first longitudinal axis L1, a transition section 41, and a second straight section 51 having a second longitudinal axis L2. The first straight section 11 and the second straight section 51 are in communication with each other through the transition section 41. In an aspect, the transition section 41 may comprise two segments, a first transition segment 21 and a second transition segment 31. The first transition segment 21 has a first transition longitudinal axis I1 and the second transition segment 31 has a second transition longitudinal axis I2 as shown. In an embodiment, the first longitudinal axis L1 and the second longitudinal axis L2 define an angle Ψ1 with each other. In an embodiment, the angle Ψ1 is obtuse. In an aspect, the catalyst distributor 60 may be located below the air distributor 80 or above the catalyst bed.

In accordance with an exemplary embodiment, the first straight section 11 of the first header 66 comprises an angular nozzle 68a in downstream communication with the first opening 64. The angular nozzle 68a defines an acute angle α1 with the first longitudinal axis L1 of the first header 66. A longitudinal axis a defined by the angular nozzle 68a defines an acute angle α1 with the first longitudinal axis L1 of the first header 66. The angular nozzle 68a discharges catalyst into the regenerator vessel 50 at an acute angle α1 to the first longitudinal axis L1. In an embodiment, a plurality of nozzles 68a, 68b, 68c, 68d, 68e, and 68f are in downstream communication with the first header 66 each have an axis that defines an acute angle with the first longitudinal axis L1. As shown, the catalyst distributor 60 comprises a plurality of nozzles 68a, 68b, 68c, 68d, 68e, and 68f on both sides of the first header 66. Nozzles 68a, 68b, and 68c are on a first side S1 and nozzles 68d, 68e and 68f are on the second side S2 or the opposite side of the first side S1 of the first header 66. Although, six nozzles 68a, 68b, 68c, 68d, 68e, and 68f are shown, the catalyst distributor 60 may comprise more or less than six nozzles on the first header 66. The nozzles 68b, 68c, 68d, 68e, and 68f define acute angles β1, γ1, α2, β2, and γ2 with the first longitudinal axis L1 of the first header 66, respectively. In other words, longitudinal axes a, b, c, d, e, and f defined by the nozzles 68a, 68b, 68c, 68d, 68e, and 68f define acute angles with the first longitudinal axis L1. The plurality of nozzles 68a, 68b, 68c, 68d, 68e, and 68f may discharge catalyst into the regenerator vessel 50 at an acute angle to the first longitudinal axis L1.

In an aspect, the nozzle 68c closest to the spent catalyst pipe 56 and perhaps closest to the inner surface 53 of the regenerator is a proximate nozzle 68c. In an exemplary embodiment, the proximate nozzle 68c is perpendicular to the first longitudinal axis L1. For the proximate nozzle 68c, the angle γ1 is a right angle to the first longitudinal axis L1. In an embodiment, the transition section 41 can have segments that are trapezoidal in horizontal cross section. Though, as shown in FIG. 2, the first straight section 11 comprises the nozzles 68a, 68b, 68c, 68d, 68e, and 68f, the second straight section 51 may also comprise a plurality of nozzles. In an aspect, the first header 66 comprises both the first straight section 11 and the second straight section 51 and a plurality of nozzles.

Nozzles 68a, 68b and 68c are on the first side S1 of the first header 66 and nozzles 68d, 68e, and 68f are on the second side S2 of the first header 66. Nozzles closest to each other on opposite sides of the first header 66 may have the same length and define the same angle with the first longitudinal axis L1. In an embodiment, the angular nozzles 68a, 68b, and 68c on the first side S1 of the first header 66 define included angles α1, β1, and γ1 with first longitudinal axis L1 that are each different from each other. In another embodiment, the angular nozzles 68a, 68b, and 68c on the first side S1 of the first header 66 define included angles α1, β1, and γ1 with the first longitudinal axis L1 some or all of which are the same. In another embodiment, the angular nozzles 68d, 68e, and 68f on the second side S2 of the first header 66 define included angles α2, β2, and γ2 with first longitudinal axis L1 that are each different. In another embodiment, the angular nozzles 68d, 68e, and 68f on the second side S2 of the first header 66 define included angles α2, β2, and γ2 with the first longitudinal axis L1 some or all of which are the same.

The first header 66 may include a distal nozzle 68g on the outer end 70 of the first header 66 that defines a longitudinal axis g that may be aligned with the first longitudinal axis L1. In an aspect, the first header 66 may comprise a plurality of drain slots 181 shown in phantom in the bottom of the first header 66 to prevent accumulation of the catalyst in the header bottom after shutting down or during operation.

In an embodiment, the included angles that the angular nozzle 68a, 68b, 68c, 68d, 68e, and 68f define with the first longitudinal axis L1 may successively decrease as the nozzles are positioned further away from the first opening 64 or a central point D of the spent catalyst pipe 56 and closer to the outer end 70 of the first header 66. The nozzles 68a, 68b, 68c, 68d, 68e, and 68f discharge catalyst at included angles to the first longitudinal axis L1 at angles that may successively decrease as the distance from the first opening 64 or the central point D of the spent catalyst pipe 56 increases. This allows the nozzles to radially project catalyst in equal flow rates across the bed from an eccentric position in the regenerator vessel 50. Additionally, in an embodiment, the length of the angular nozzles 68a, 68b, 68c, 68d, 68e, and 68f on the first header 66 may successively increase as the nozzles are positioned further away from the first opening 64 or the central point D of the spent catalyst pipe 56 and closer to the outer end 70 of the first header 66. The opposite position of the catalyst outlet 96 relative to the distributor 60 is also seen in FIG. 2 in which outlet 96 is disposed in a quadrant diametrically opposed to the quadrant containing the first opening 64 or the central point D of the spent catalyst pipe 56.

In an exemplary embodiment, the catalyst distributor 60 may comprise a second opening 64′ in the spent catalyst pipe 56. Preferably, the second opening 64′ may communicate with a second header 66′ as shown in the FIG. 2. In an aspect, the second header 66′ may be positioned opposite to a center line X connecting the center C of the regenerator vessel 50 with the central point D of the spent catalyst pipe 56. Elements of the second header 66′ may have the same configuration as in the first header 66 and bear the same respective reference number and have similar operating conditions and functioning as the first header 66. Since the second header 66′ is located opposite to the first header 66 inside the regenerator vessel 50, the elements of the second header 66′ are represented with the same respective reference number as in the first header 66. However, the elements of the second header 66′ are marked with the prime (′) symbol to depict the difference in orientation/position for the second header 66′ located opposite to the first header 66 inside the regenerator vessel 50. The functioning and description of the second header 66′ of the catalyst distributor 60 is same as described above for the first header 66.

In an aspect, the first header 66 and the second header 66′ may be symmetrical to each other about imaginary axis of symmetry line X. In an embodiment, the first header 66 may comprise one or more baffles located inside one or more of the first straight section 11, the second straight section 51, and the transition section 41 to deflect catalyst away from one nozzle to another nozzle to prevent bypassing the one nozzle. In another embodiment, the second header 66′ may comprise one or more baffles located inside one or more of the first straight section 11′, the second straight section 51′, and the transition section 41′ to deflect catalyst away from one nozzle to another nozzle to prevent bypassing the one nozzle.

FIG. 3 provides an enlarged, partial elevational view of the catalyst distributor 60 of FIG. 2. As shown, the first header 66 with the first straight section 11, the transition section 41, and the second straight section 51 can be seen in a partial side view of the catalyst distributor 60 of FIG. 2. The first straight section 11 defines a height H. In an aspect, the height of the first straight section 11, the height of the second straight section 51 and the height of the transition section 41 may all be the same as height “H”. For a first header 66 with a circular cross section, the height H is the diameter. The first header 111 may have other types of cross sections such as obround and rectangular. In another aspect, one, two or all of the height of the first straight section 11, the height of the second straight section 51, and the height of the transition section 41 may be different. Referring to the first header 66, a bottom 72a of the nozzle 68a, a bottom 72b of the second angular nozzle 68b, and a bottom 72c of nozzle 68c, may be disposed above a bottom 71 of the first header 66 or the bottom of the first section 11. In an embodiment, the bottom 71 of the first header 66 or the bottom of the first section 11 is defined as the lowest point of the first header 66. The positioning of the nozzles 68a, 68b, and 68c with respect to the first section 11 provides even catalyst distribution. The nozzles 68a, 68b, and 68c may also have a height h. In an embodiment, about 50% of the height h of the nozzles 68a, 68b, and 68c may be disposed below the first longitudinal axis L1 of the first section 11. In another embodiment the nozzles the nozzles 68a, 68b, and 68c can be disposed below the first longitudinal axis L1 of the first section 11.

FIG. 3 also illustrates that the longitudinal axis a defined by the nozzle 68a may be horizontal in an embodiment. In another embodiment, the longitudinal axis a defined by the nozzle 68a may angle downwardly as the distance from the catalyst pipe 56 increases. In an embodiment, the first longitudinal axis L1 of the first section 11 may also be horizontal. FIG. 3 also illustrates that longitudinal axis b and the longitudinal axis c defined by the nozzle 68b and 68c, respectively, may be horizontal in an embodiment. The distal nozzle 68g is also shown in FIG. 3. The distal nozzle 68g has an axis g which may be horizontal. All of the longitudinal axes a, L1, b, c and g may be coplanar.

A cap 62 operatively connected to the top 65 of the spent catalyst pipe 56 is also shown. The first opening 64 in upstream fluid communication with the first section 11 is also shown.

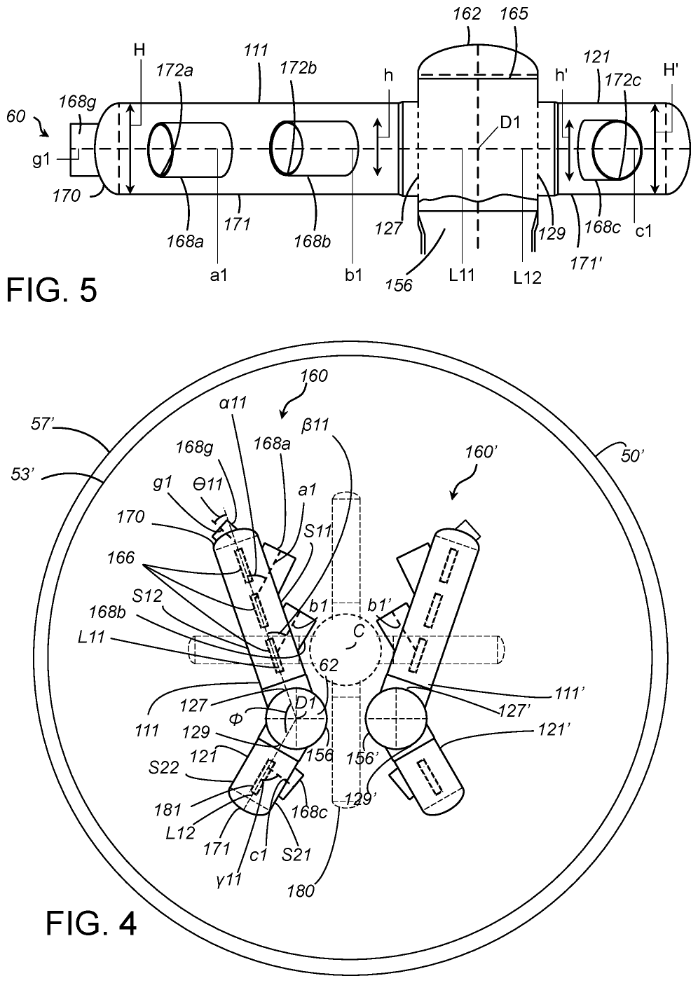

A plan view of the regenerator vessel showing multiple catalyst distributors inside a regenerator vessel 50′ is shown in FIG. 4. In an exemplary embodiment shown in FIG. 4, two catalyst distributors are shown inside the regenerator vessel 50′. The regenerator vessel 50′ has a wall 57′ with an inner surface 53′. In the exemplary embodiment shown in FIG. 4, two distributors 160 and 160′ having another configuration or design than the previously described embodiments are depicted in accordance with the present disclosure. A first catalyst distributor 160 is located in a left half of the regenerator vessel 50′. As shown in the FIG. 4, the first catalyst distributor 160 comprises a first header 111 and a second header 121. The first header 111 is in fluid communication with a first opening 127 and the second header 121 is in fluid communication with a second opening 129 of a first spent catalyst pipe 156. In the exemplary embodiment shown in FIG. 4, the first header 111 is longer than the second header 121. The first catalyst distributor 160 is located above the air distributor 180. Referring to the first catalyst distributor 160, the first header 111 defines a first longitudinal axis L11 and an angular nozzle 168a in downstream communication with the first header 111. The angular nozzle 168a defines an acute angle α11 with the first longitudinal axis L11 of the first header 111. A longitudinal axis a1 defined by the angular nozzle 168a defines an acute angle α1l with the first longitudinal axis L11 of the first header 111. The angular nozzle 168a discharges catalyst into the regenerator vessel 50′ at an acute angle α11 to the first longitudinal axis L11. In an embodiment, the first header 111 comprises at least two nozzles, a first angular nozzle 168a and a second angular nozzle 168b in downstream communication with the first opening 127 each having an axis that defines an acute included angle with longitudinal axis L11. However, the first header 111 may comprise more than two angular nozzles in communication with the first opening 127. The second angular nozzle 168b defines an acute angle β11 with the first longitudinal axis L11 of the first header 111. The longitudinal axis a1 of the first angular nozzle 168a and the longitudinal axis b1 of the second angular nozzle 168b both define acute included angles with the first longitudinal axis L11. The two nozzles 168a and 168b may discharge catalyst into the regenerator vessel 50′ at an acute angle to the first longitudinal axis L11. As shown in FIG. 4, the first angular nozzle 168a and the second angular nozzle 168b are located on a first side S11 of the first header 111. However, the first header 111 may comprise one or more angular nozzles on the second side S12, opposite to the first side S11 of the first header 111. In another aspect, the one or more angular nozzles may be located on the second side S12 of the header 111. The first angular nozzle 168a and the second angular nozzle 168b are directed inwardly in the regenerator vessel 50′.

Nozzles on the first side S11 of the first header 111 may have the same length and define the same angle with the longitudinal axis L11. In an embodiment, the angular nozzles 168a and 168b are on the first side S11 of the header 111, the angular nozzle 168a defines an angle α11 and the angular nozzle 168b defines an angle β11 with the first longitudinal axis L11 that are each different from each other. The first header 111 may include a distal nozzle 168g on the outer end 170 of the first header 111 that provides a longitudinal axis g1 that defines an angle θ11 with the first longitudinal axis L11. In an aspect, the distal nozzle 168g defines an acute included angle θ11 with the first longitudinal axis L11 of the first header 166. In other words, longitudinal axis g1 defined by the distal nozzle 168g define an acute included angle θ11 with the first longitudinal axis L11. The distal nozzle 168g may be directed outwardly in the regenerator vessel 50.

In an embodiment, the first header 111 may comprise a plurality of drain slots 166 shown in phantom in the bottom of the first header 111 to prevent accumulation of the catalyst in the header bottom after shutting down or during operation. In an aspect, the first catalyst distributor 160 may be located below the air distributor 180 and the flutes 182.

In an exemplary embodiment, the first catalyst distributor 160 may comprise a second opening 129 in the spent catalyst pipe 56. Preferably, the second opening 129 may communicate with a second header 121 of the first catalyst distributor 160 as shown in the FIG. 4. The second header 121 may have a second longitudinal axis L12. In an aspect, the first header 111 may be longer than the second header 121. In another aspect, the first header 111 may be equal in length as the second header 121. In yet another aspect, the first header 111 may be shorter in length than the second header 211. In another aspect, the first header 111 and the second header 121 may be symmetrical to each other. In a preferred embodiment, the first header 111 is longer than the second header 121. The second header 121 defines the second longitudinal axis L12 and provides an angular nozzle 168c in downstream communication with the second opening 129. As shown in FIG. 4, the angular nozzle 168c is located on a first side S21 of the second header 121. However, the second header 121 may comprise one or more angular nozzles on the second side S22, opposite to the first side S21 of the second header 121. Although FIG. 4 shows single angular nozzle 168c, the second header 121 may comprise more than one angular nozzle on the first side S21 and/or the second side S22 of the second header 121. The angular nozzle 168c defines an acute angle γ11 with the second longitudinal axis L12 of the second header 121. In other words, a longitudinal axis c1 defined by the angular nozzle 168c defines an acute angle γ11 with the second longitudinal axis L12 of the second header 121. The angular nozzle 168c discharges catalyst into the regenerator vessel 50′ at an acute angle γ11 to the second longitudinal axis L12. The angular nozzle 168c on the second header 121 may be directed inwardly. As shown in FIG. 4, the angular nozzle 168c is located on the first side S21 of the second header 121 which is the same first side S11 of the first header 111 on which angular nozzles are located. However, the second header 121 may comprise one or more angular nozzles on the other side S22 of the second header 121. In another aspect, the one or more angular nozzles on the second side S22 may be located on the side opposite to the first side S21 of the second header 121. In an embodiment, the second header 121 may comprise one or more drain slots 181 in the bottom of the second header 121 to prevent accumulation of the catalyst in the header bottom after shutting down or during operation.

The first catalyst distributor 160 including the first header 111 and the second header 121 may occupy two quadrants of the cross section of the regenerator vessel 50′. In an aspect, the first longitudinal axis L11 and the second longitudinal axis L12 define an angle (with each other. In an exemplary embodiment, the angle Φ is obtuse.

Another exemplary embodiment of the catalyst distributor inside the regenerator vessel 50′ is addressed with reference to a second catalyst distributor 160′ as shown in FIG. 4. As shown in FIG. 4, the second catalyst distributor 160′ may be located in a right half of the regenerator vessel 50′. Elements of the catalyst distributor 160′ may have the same configuration as in the first catalyst distributor 160 and bear the same respective reference number and have similar operating conditions and functioning as the second catalyst distributor 160. As shown, the second catalyst distributor 160′ is similar to the first catalyst distributor 160 and comprises two headers, a first header 111′ and a second header 121′. The first header 111′ is in fluid communication with a first opening 127′ and the second header 121′ is in fluid communication with a second opening 129′ of the second spent catalyst pipe 156′. Since the second catalyst distributor 160′ is located in the right half of the regenerator vessel 50′, the elements of the second catalyst distributor 160′ are represented with the same respective reference number as in the first catalyst distributor 160 located in the left half of the regenerator vessel 50′. However, the elements of the second catalyst distributor 160′ are marked with the prime (′) symbol to depict the difference in orientation/position for the second catalyst distributor 160′ located in the right half as compared to the first catalyst distributor 160 located in the left half of the regenerator vessel 50′. The functioning and description of the second catalyst distributor 160′ is same as described above for the first catalyst distributor 160.

In an aspect, a first catalyst distributor 160 and a second catalyst distributor 160′ may be present inside the regenerator vessel 50′ as shown in FIG. 4 for distributing catalyst into the regenerator vessel 50′. In the embodiment with two catalyst distributors, the first catalyst distributor 160 and the second catalyst distributor 160′, the regenerator riser 54 may comprise two catalyst pipes, a first spent catalyst pipe 156 for feeding the catalyst to the first catalyst distributor 160 and a second spent catalyst pipe 156′ for feeding the catalyst to the second catalyst distributor 160′.

FIG. 5 provides an enlarged, partial elevational view of the catalyst distributor 160 with the first header 111 defining a height H and the second header 121 defining a height H′. For a header 111 with a circular cross section, the height H is the diameter. Other types of cross sections such as obround and rectangular are envisioned for the header 111. In an aspect, the height H of the first header 111 and the height H′ of the second header 121 may be the same. In another aspect, the height H of the first header 111 and the height H′ of the second header 121 may be different. Referring to the first header 111, a bottom 172a of the first angular nozzle 168a and a bottom 172b of the second angular nozzle 168b may be disposed above a bottom 171 of the first header 111. In an embodiment, the bottom 171 is defined as the lowest point of the first header 111. The positioning of the first angular nozzle 168a with respect to the first header 111 provides even catalyst distribution. The first angular nozzle 168a also has a height h. In an embodiment, about 50% of the height h of the first angular nozzle 168a is disposed below the first longitudinal axis L11 of the first header 111. In another embodiment the first angular nozzle 168a may be disposed below the first longitudinal axis L11 of the first header 111.

FIG. 5 also illustrates that longitudinal axis a1 defined by the first angular nozzle 111a may be horizontal in an embodiment. In another embodiment, the longitudinal axis a1 defined by the first angular nozzle 111a may angle downwardly as the distance from the catalyst pipe 156 increases. In an embodiment, the first longitudinal axis L11 of the first header 111 may also be horizontal. The second angular nozzle 168b may have a similar height h as the first angular nozzle 168a. In an embodiment, about 50% of the height h of the second angular nozzle 168b is disposed below the first longitudinal axis L11 of the first header 111. FIG. 5 also illustrates that longitudinal axis b1 defined by the second angular nozzle 168b may be horizontal in an embodiment. The distal nozzle 168g is also shown in FIG. 5. The distal nozzle 168g has an axis g1 which may be horizontal.

Referring to the second header 121, a bottom 172c of the angular nozzle 168c may be disposed above a bottom 171′ of the second header 121. In an embodiment, the bottom 171′ is defined as the lowest point of the second header 121. The angular nozzle 168c also has a height h′. In an aspect, the height h′ of the angular nozzle 168c and the height h of the first angular nozzle 168c may be the same. In another aspect, the height h′ of the angular nozzle 168c and the height h of the first angular nozzle 168c may be different. In an embodiment, about 50% of the height h′ of the first angular nozzle 168a is disposed below the second longitudinal axis L12 of the second header 121. FIG. 5 also illustrates that longitudinal axis c1 defined by the angular nozzle 168c is horizontal in an embodiment. In an embodiment, the second longitudinal axis L12 of the second header 121 is also horizontal.

A top head 165 of the first spent catalyst pipe 156 is also shown. In an alternate embodiment, the cap 162 of the catalyst distributor 60 is also shown. The catalyst distributor 160 has the first opening 127 in upstream communication with the first header 111 and the second opening 129 in upstream communication with the second header 121 as shown in the FIG. 5.

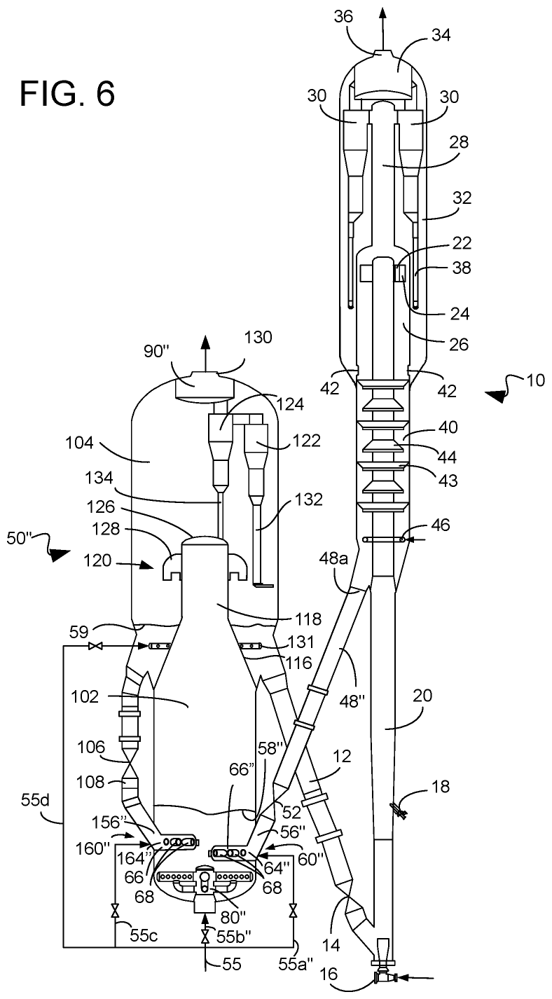

FIG. 6 shows an embodiment in a regenerator vessel 50″ that is a combustor type of regenerator, which may use hybrid turbulent bed-fast fluidized conditions in a high-efficiency regenerator vessel 50″ for completely regenerating coked catalyst. Elements in FIG. 6 with the same configuration as in FIG. 1 will have the same reference numeral as in FIG. 1. Elements in FIG. 6 which have a different configuration as the corresponding element in FIG. 1 will have the same reference numeral but designated with a double prime symbol (″). The configuration and operation of the reactor section 10 in FIG. 6 is essentially the same as in FIG. 1 and the foregoing description is incorporated by reference into the embodiment of FIG. 6. However, the reactor catalyst conduit 48″ communicates with a catalyst distributor 60″. An inlet 48a of the reactor catalyst conduit 48″ is in communication with the reactor vessel 32. A predominant portion of the reactor catalyst conduit 48″ is disposed above the catalyst distributor 60″. A fluidizing gas which may be a combustion gas is provided by fluidizing gas line 55a″ to propel the coked catalyst through the catalyst distributor 60″. However, relatively less fluidizing gas from fluidizing gas line 55a″ is required than in the embodiment of FIG. 1 because gravity assists in the transport of coked catalyst in reactor catalyst conduit 48″ since the portion of the reactor catalyst conduit 48″ immediately upstream the catalyst distributor 60″ is disposed above the catalyst distributor 60″. Coked catalyst regulated by control valve 52 descends the reactor catalyst conduit 48″ and enters a lower or first chamber 102 of the combustor regenerator vessel 50″ through a catalyst pipe 56″.

The catalyst distributor 60″ in downstream communication with an opening 64″ of the catalyst pipe 56″ and the outlet from fluidizing gas line 55a″ distributes coked catalyst to the lower chamber 102 of combustor regenerator vessel 50″. The opening 64″ of the catalyst pipe 56″ communicates with a header 66″ which may define a longitudinal axis. Additionally, the header 66″ may be angular to the immediately upstream portion of the reactor catalyst conduit 48′. The catalyst distributor 60″ comprises at least one and preferably a plurality of nozzles 68 communicating with the header 66 for discharging catalyst into the lower chamber 102 of the regenerator vessel 50″. The catalyst distributor 60″ discharges coked catalyst in an embodiment from under a top surface of a dense catalyst bed 58″, and the catalyst distributor 60″ is preferably submerged in the bed below the top surface. Additionally, the catalyst distributor 60″ is disposed in an eccentric position in the combustor regenerator vessel 50″ and projects catalyst into the dense catalyst bed 58″ therefrom across the entire cross-section of the dense bed. The fluidizing gas from the fluidizing gas line 55a″ assists in the projection of the catalyst into the bed from catalyst distributor 60″. If the fluidizing gas contains oxygen to provide oxygen for combustion requirements, fluidizing gas line 55a″ may be a branch from combustion gas line 55″. The header 66 and nozzles 68 of the catalyst distributor 60″ may be configured as described with respect to FIGS. 1-5.

A combustion gas distributor 80″ distributes gas from distributor gas line 55b″ to the lower chamber 102. Combustion gas line 55″ may feed the distributor gas line 55b″. The combustion gas contacts coked catalyst entering from catalyst distributor 60″ and lifts the catalyst at a superficial velocity of combustion gas in the lower chamber 102 of at least 1.1 m/s (3.5 ft/s) under fast fluidized flow conditions. In an embodiment, flow conditions in the lower chamber 102 will include a catalyst density of from 48 to 320 kg/m3 (3 to 20 lb/ft3) and a superficial gas velocity of 1.1 to 2.2 m/s (3.5 to 7 ft/s). In an embodiment, to accelerate combustion of the coke in the lower chamber 102, hot regenerated catalyst from a dense is catalyst bed 59 in an upper or second chamber 104 may be recirculated into the lower chamber 102 via an external recycle catalyst conduit 108 regulated by a control valve 106. Hot regenerated catalyst enters an inlet of recycle catalyst conduit 108 which is in downstream communication with the upper chamber 104. The outlet end of the recycle catalyst conduit may be in upstream communication with a second catalyst distributor 160″ in the lower chamber 102. Although described differently herein, it is contemplated that recycle catalyst could be added to the lower chamber 102 without using a second catalyst distributor 160″. It is also contemplated that recycle catalyst could be added to the lower chamber 102 using the second catalyst distributor 160″ but the coked catalyst in reactor catalyst conduit 48 be added without distributor 60″. The hot regenerated catalyst may enter the lower chamber 102 through the second catalyst distributor 160″ that may be disposed at a higher height than the first catalyst distributor 60″. The first catalyst distributor 60″ and the second catalyst distributor 160″ are preferably disposed on opposite sides of the regenerator vessel 50″. Recirculation of regenerated catalyst, by mixing hot catalyst from the dense catalyst bed 59 with relatively cool coked catalyst from the reactor catalyst conduit 48″ entering the lower chamber 102, raises the overall temperature of the catalyst and gas mixture in the lower chamber 102. A predominant portion of the recycle catalyst conduit 108 and a portion of recycle catalyst conduit 108 immediately upstream of the second catalyst distributor 160″ is disposed above the second catalyst distributor 160″.

The second catalyst distributor 160″ in downstream communication with an opening 164″ of a second catalyst pipe 156″ and an outlet from recycle gas line 55c distributes recycled regenerated catalyst to the lower chamber 102 of combustor regenerator vessel 50″. If the recycle gas contains oxygen it may be a branch from combustion gas line 55. The opening 164″ of a second catalyst pipe 156″ communicates with a header 66 which may comprise a longitudinal axis. Additionally, the header 66 may be angular to the immediately upstream portion of the recycle catalyst conduit 108. The second catalyst distributor 160″ comprises at least one and preferably a plurality of nozzles 68 communicating with the header 66 for discharging catalyst into the combustor regenerator vessel 50″. The second catalyst distributor 160″ discharges catalyst in an embodiment from under a top surface of a dense catalyst bed 58″, and the second catalyst distributor 160″ is preferably submerged in the bed below the top surface. In an exemplary embodiment of the present disclosure, the first catalyst distributor 60″ the second catalyst distributor 160″ both have the same configuration as the catalyst distributor 60 shown in FIG. 2.

The mixture of catalyst and combustion gas in the lower chamber 102 ascend through a frustoconical transition section 116 to the transport, riser section 118 of the lower chamber 102. The riser section defines a tube and extends upwardly from the lower chamber 102. The mixture of catalyst and gas travels at a higher superficial gas velocity than in the lower chamber 102 due to the reduced cross-sectional area of the riser section 118 relative to the cross-sectional area of the lower chamber 102 below the transition section 116. Hence, the superficial gas velocity will usually exceed about 2.2 m/s (7 ft/s). The riser section 118 will have a relatively lower catalyst density of less than about 80 kg/m3 (5 lb/ft3).

The mixture of catalyst particles and flue gas is discharged from an upper portion of the riser section 118 into the upper chamber 104. Predominantly completely regenerated catalyst may exit the top of the riser section 118, but arrangements in which partially regenerated catalyst exits from the lower chamber 102 are also contemplated. Discharge is effected through a disengaging device 120 that separates a majority of the regenerated catalyst from the flue gas. Initial separation of catalyst upon exiting the riser section 118 minimizes the catalyst loading on cyclone separators 122, 124 or other downstream devices used for the essentially complete removal of catalyst particles from the flue gas, thereby reducing overall equipment costs. In an embodiment, catalyst and gas flowing up the riser section 118 impact a top elliptical cap 126 of the riser section 118 and reverse flow. The catalyst and gas then exit through downwardly directed openings in radial disengaging arms 128 of the disengaging device 120. The sudden loss of momentum and downward flow reversal cause at least about 70 wt-% of the heavier catalyst to fall to the dense catalyst bed 59 and the lighter flue gas and a minor portion of the catalyst still entrained therein to ascend upwardly in the upper or second chamber 104. Downwardly falling, disengaged catalyst collects in the dense catalyst bed 59. Catalyst densities in the dense catalyst bed 59 are typically kept within a range of from about 640 to about 960 kg/m3 (40 to 60 lb/ft3).

A fluidizing gas line 55d delivers fluidizing gas to the dense catalyst bed 59 through a fluidizing distributor 131. Fluidizing gas may be combustion gas, typically air, and may branch from combustion gas line 55. In combustor regenerator vessel 50″, in which full combustion of coke is effected in the lower chamber 102, approximately no more than 2 wt % of the total gas requirements within the process enters the dense catalyst bed 59 through the fluidizing distributor 131 with the remainder being added to the lower chamber 102. In this embodiment, gas is added to the upper chamber 104 not for combustion purposes, but only for fluidizing purposes, so the catalyst will fluidly exit through the catalyst conduits 108 and 12. Combustion gas added via gas lines 55a″ and 55c will account for about 10-20 wt % of the gas to the combustor regenerator vessel 50″. If air is the combustion gas, typically 13 to 15 kg (lbs) of air is required per kilogram (pound) of coke fed on catalyst to the regenerator. The combustor regenerator vessel 50″ typically has a temperature of about 594° C. to about 704° C. (1100° F. to 1300° F.) in the lower chamber 102 and about 649° C. (1100° F.) to about 760° C. (1400° F.) in the upper chamber 104. Pressure may be between 35 kPa (gauge) (5 psig) and 414 kPa (gauge) (60 psig) in both chambers.

The combined flue and fluidizing gas and entrained particles of catalyst enter one or more separation means, such as the cyclone separators 122, 124, which separates catalyst fines from the gas. Flue gas, relatively free of catalyst is withdrawn from the combustor regenerator vessel 50″ through an exit conduit 130 while recovered catalyst is returned to the dense catalyst bed 59 through respective diplegs 132, 134. Catalyst from the dense catalyst bed 59 is transferred through the regenerated catalyst conduit 12 back to the reactor section 10 where it again contacts feed as the FCC process continues.

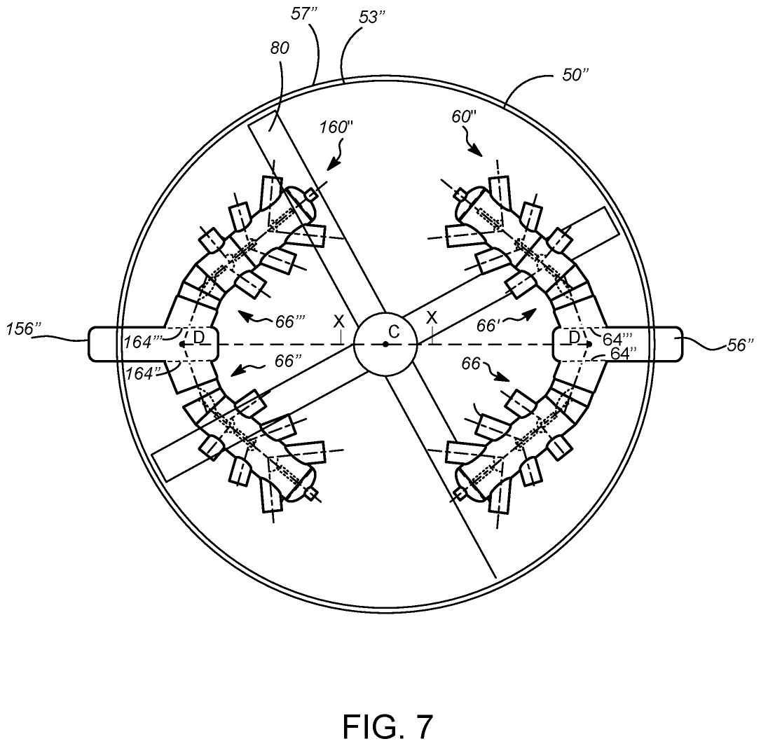

A plan view of an exemplary embodiment of the two catalyst distributors 60″ and 160″ of FIG. 6 inside the regenerator vessel 50″ is shown in FIG. 7. The regenerator vessel 50″ has a wall 57″ with an inner surface 53″. In the exemplary embodiment shown in FIG. 7, the catalyst pipes are in fluid communication with two catalyst distributors. The first catalyst distributor 60″ shown in FIG. 7 is in fluid communication with a first catalyst pipe 56″. The second catalyst distributor 160″ is similar to the first catalyst distributor 60′. The second catalyst distributor 160″ is in fluid communication with the second catalyst pipe 156″. The first catalyst distributor 60″ and the second catalyst distributor 160″ are located in the opposite halves and are opposed to each other inside the regenerator vessel 50″ as shown in FIG. 7. In accordance with an embodiment of the present disclosure, the first catalyst pipe 56″ is a spent catalyst pipe and the second catalyst pipe 156″ is a regenerated catalyst pipe.

The first catalyst distributor 60″ is connected with the first spent catalyst pipe 56″ having two openings, a first opening 64″ and a second opening 64″′. The first header 66 of the first catalyst distributor 60″ is in fluid communication with the first catalyst pipe 56″ via the first opening 64″. Similarly, the second header 60′ of the first catalyst distributor 60″ is in fluid communication with the first catalyst pipe 56″ via the second opening 64″′. In an aspect, the first catalyst distributor 60″ having two headers 66 and 66′ has the same configuration and is similar to the catalyst distributor 60 with two headers as shown in FIG. 2. Referring to the first catalyst distributor 60″, elements of the first header 66 and the second header 66′ may have the same configuration and bear the same respective reference number and function similarly to the catalyst distributor 60 with two headers shown in FIG. 2.

Another exemplary embodiment of the catalyst distributor inside the regenerator vessel 50″ is addressed with reference to the second catalyst distributor 160″ as shown in FIG. 7. In the exemplary embodiment as shown in FIG. 7, the regenerator vessel 50″ comprises a second spent catalyst pipe 156″. The second spent catalyst pipe 156″ has two openings, a first opening 164″ and a second opening 164″′. The second catalyst distributor 160″ is connected with the second spent catalyst pipe 156″. As shown, the first header 66″ of the second catalyst distributor 160″ is in fluid communication with the second spent catalyst pipe 156″ via the first opening 164″. Similarly, the second header 66″′ of the second catalyst distributor 160″ is in fluid communication with the second spent catalyst pipe 156″ via the second opening 164″′. Referring to the second catalyst distributor 160″, elements of the first header 66″ and the second header 66″′ may have the same configuration as in the first catalyst distributor 60″ and bear the same respective reference number and function similarly to the first catalyst distributor 60″. The functioning and description of the second catalyst distributor 160″ is same as described above for the first catalyst distributor 60″.

### Example

We conducted Computational Fluid Dynamics (CFD) modeling to test the disclosed distributor of FIGS. 2 and 3 in the first stage of a two-stage regenerator. Unlike the embodiment in FIG. 1, the distributor was modeled below the air grid. The first stage had an air rate of 141 kg/s and the distributor was tasked with distributing 2798 kg/s of catalyst to the first stage.

CFD modeling revealed that the catalyst density was fairly uniform at the level of the distributor, just below the air grid and at the top of the dense bed. No hot pockets were observed and the air residence time was also favorable. Catalyst was observed discharging from each nozzle in the distributor.

### Specific Embodiments

While the following is described in conjunction with specific embodiments, it will be understood that this description is intended to illustrate and not limit the scope of the preceding description and the appended claims.

A first embodiment of the present disclosure is a catalyst regenerator vessel for combusting carbonaceous deposits from catalyst comprising a combustion gas distributor in fluid communication with a combustion gas line for introducing a combustion gas to the vessel; a catalyst pipe with a first opening and a second opening; a catalyst distributor in fluid communication with the first opening in the catalyst pipe, the catalyst distributor comprising a first header in fluid communication with the first opening in the catalyst pipe for distributing catalyst to the vessel, an angular nozzle in the first header projecting at an angle to a longitudinal axis of the first header for distributing catalyst into the vessel. An embodiment of the present disclosure is one, any or all of prior embodiments in this paragraph up through the first embodiment in this paragraph wherein the catalyst distributor comprises a second header and an angular nozzle in the second header projecting at an angle to a longitudinal axis of the second header for distributing catalyst into the vessel. An embodiment of the present disclosure is one, any or all of prior embodiments in this paragraph up through the first embodiment in this paragraph further comprising a cap on a top catalyst pipe. An embodiment of the present disclosure is one, any or all of prior embodiments in this paragraph up through the first embodiment in this paragraph wherein the first header includes a series of angular nozzles on a side of the header each projecting at an angle from the longitudinal axis of the header for distributing catalyst into the vessel, an angle with the longitudinal axis of each angular nozzle in the series decreases for each angular nozzle the farther the angular nozzle is from the first opening. An embodiment of the present disclosure is one, any or all of prior embodiments in this paragraph up through the first embodiment in this paragraph wherein the angular nozzle defines an acute angle with the longitudinal axis of the first header. An embodiment of the present disclosure is one, any or all of prior embodiments in this paragraph up through the first embodiment in this paragraph wherein the first header has a distal nozzle for distributing catalyst into the vessel, the distal nozzle being aligned with a longitudinal axis of the first header. An embodiment of the present disclosure is one, any or all of prior embodiments in this paragraph up through the first embodiment in this paragraph wherein the distal nozzle is angularly aligned with the longitudinal axis of the header. An embodiment of the present disclosure is one, any or all of prior embodiments in this paragraph up through the first embodiment in this paragraph wherein the first header is located above the combustion gas distributor in the vessel for distributing catalyst into the vessel. An embodiment of the present disclosure is one, any or all of prior embodiments in this paragraph up through the first embodiment in this paragraph wherein the second header is located below the combustion gas distributor in the vessel for distributing catalyst into the vessel. An embodiment of the present disclosure is one, any or all of prior embodiments in this paragraph up through the first embodiment in this paragraph wherein the second header comprises a plurality of nozzles including a series of angular nozzles on a side of the second header each projecting at an angle from a longitudinal axis of the second header for distributing catalyst into the vessel, wherein an angle with the longitudinal axis of each angular nozzle in the series decreases for each angular nozzle the farther the nozzle is from the second opening. An embodiment of the present disclosure is one, any or all of prior embodiments in this paragraph up through the first embodiment in this paragraph wherein the first header comprises one or more baffles located inside of the first header to deflect catalyst away from a nozzle to another nozzle. An embodiment of the present disclosure is one, any or all of prior embodiments in this paragraph up through the first embodiment in this paragraph wherein the first header and the second header are symmetrical to each other. An embodiment of the present disclosure is one, any or all of prior embodiments in this paragraph up through the first embodiment in this paragraph wherein the first header has a first section that has a longitudinal axis that is angular to a longitudinal axis of a second section of the first header. An embodiment of the present disclosure is one, any or all of prior embodiments in this paragraph up through the first embodiment in this paragraph wherein the first header comprises a proximate nozzle perpendicular to the longitudinal axis of the first header. An embodiment of the present disclosure is one, any or all of prior embodiments in this paragraph up through the first embodiment in this paragraph wherein the first header comprises a first straight section having a first longitudinal axis, a transition section, and a second straight section having a second longitudinal axis, the first straight section and the second straight section are in communication with each other through the transition section, wherein the first longitudinal axis and the second longitudinal axis are angular to each other. An embodiment of the present disclosure is one, any or all of prior embodiments in this paragraph up through the first embodiment in this paragraph wherein one or both of the first straight section and the second straight section comprise a plurality of nozzles.

A second embodiment of the present disclosure is a catalyst regenerator vessel for combusting carbonaceous deposits from catalyst comprising a combustion gas distributor in fluid communication with a combustion gas line for introducing a combustion gas to the vessel; a catalyst pipe with a first opening and a second opening, the catalyst pipe feeding a catalyst distributor being attached to the catalyst pipe, the catalyst distributor comprising a first header in fluid communication with the first opening in the catalyst pipe for distributing catalyst to the vessel, an angular nozzle in the first header projecting at an angle to a longitudinal axis of the first header for distributing catalyst into the vessel; a separator in communication with the regenerator vessel for separating gas from the catalyst; and a regenerated catalyst outlet for discharging regenerated catalyst from the vessel. An embodiment of the present disclosure is one, any or all of prior embodiments in this paragraph up through the second embodiment in this paragraph wherein the catalyst distributor comprises a second header and an angular nozzle in the second header projecting at an angle to a longitudinal axis of the second header for distributing catalyst into the vessel. An embodiment of the present disclosure is one, any or all of prior embodiments in this paragraph up through the second embodiment in this paragraph wherein the first header includes a series of angular nozzles on a side of the header each projecting at an angle from the longitudinal axis of the header for distributing catalyst into the vessel, an angle with the longitudinal axis of each angular nozzle in the series decreases for each angular nozzle the farther the angular nozzle is from the first opening.

A third embodiment of the present disclosure is a process for combusting coke from catalyst comprising delivering coked catalyst from a catalyst pipe to a catalyst distributor, the catalyst distributor comprising a first header in fluid communication with a first opening in the catalyst pipe for distributing catalyst to the vessel, an angular nozzle in the first header projecting at an angle to a longitudinal axis of the first header for distributing catalyst into the vessel; discharging catalyst from the catalyst distributor from at least two sides of the catalyst pipe into a regenerator vessel; delivering combustion gas to the regenerator vessel for combusting coke from the catalyst to produce flue gas and regenerated catalyst; separating the flue gas from the regenerated catalyst; and discharging regenerated catalyst from the regenerator vessel.

Without further elaboration, it is believed that using the preceding description that one skilled in the art can utilize the present disclosure to its fullest extent and easily ascertain the essential characteristics of this present disclosure, without departing from the spirit and scope thereof, to make various changes and modifications of the present disclosure and to adapt it to various usages and conditions. The preceding preferred specific embodiments are, therefore, to be construed as merely illustrative, and not limiting the remainder of the disclosure in any way whatsoever, and that it is intended to cover various modifications and equivalent arrangements included within the scope of the appended claims.

In the foregoing, all temperatures are set forth in degrees Celsius and, all parts and percentages are by weight, unless otherwise indicated.

1. A catalyst regenerator vessel for combusting carbonaceous deposits from catalyst comprising:
a combustion gas distributor in fluid communication with a combustion gas line for introducing a combustion gas to said vessel;
a catalyst pipe with a first opening and a second opening;
a catalyst distributor in fluid communication with said first opening in said catalyst pipe, said catalyst distributor comprising:
a first header in fluid communication with said first opening in said catalyst pipe for distributing catalyst to said vessel, an angular nozzle in said first header projecting at an angle to a longitudinal axis of said first header for distributing catalyst into said vessel.

2. The catalyst regenerator vessel of claim 1 wherein said catalyst distributor further comprises a second header, an angular nozzle in said second header projecting at an angle to a longitudinal axis of said second header for distributing catalyst into said vessel.

3. The catalyst regenerator vessel of claim 1 further comprising a cap on a top of said catalyst pipe.

4. The catalyst regenerator vessel of claim 1 wherein said first header includes a series of angular nozzles on a side of said first header each projecting at an angle from said longitudinal axis of said first header for distributing catalyst into said vessel, an angle with said longitudinal axis of each angular nozzle in the series decreases for each angular nozzle the farther said angular nozzle is from said first opening.

5. The catalyst regenerator vessel of claim 1 wherein said angular nozzle defines an acute angle with said longitudinal axis of said first header.

6. The catalyst regenerator vessel of claim 1 wherein said first header has a distal nozzle for distributing catalyst into said vessel, said distal nozzle being aligned with a longitudinal axis of said first header.

7. The catalyst regenerator vessel of claim 6 wherein said distal nozzle is angular to the longitudinal axis of said header.

8. The catalyst regenerator vessel of claim 1 wherein said first header is located above said combustion gas distributor in said vessel for distributing catalyst into said vessel.

9. The catalyst regenerator vessel of claim 2 wherein said second header is located below said combustion gas distributor in said vessel for distributing catalyst into said vessel.

10. The catalyst regenerator vessel of claim 2 wherein said second header comprises a plurality of nozzles including a series of angular nozzles on a side of said second header each projecting at an angle from a longitudinal axis of said second header for distributing catalyst into said vessel, wherein an angle with the longitudinal axis of each angular nozzle in the series decreases for each angular nozzle the farther the nozzle is from said second opening.

11. The catalyst regenerator vessel of claim 1 wherein said first header comprises one or more baffles located inside of said first header to deflect catalyst away from a nozzle to another nozzle.

12. The catalyst regenerator vessel of claim 2 wherein said first header and said second header are symmetrical to each other.

13. The catalyst regenerator vessel of claim 1 wherein said first header has a first section that has a longitudinal axis that is angular to a longitudinal axis of a second section of said first header.

14. The catalyst regenerator vessel of claim 1 wherein said first header comprises a proximate nozzle perpendicular to the longitudinal axis of said first header.

15. The catalyst regenerator vessel of claim 1 wherein the first header comprises a first straight section having a first longitudinal axis, a transition section, and a second straight section having a second longitudinal axis, the first straight section and the second straight section are in communication with each other through the transition section, wherein the first longitudinal axis and the second longitudinal axis are angular to each other.

16. The catalyst regenerator vessel of claim 15 wherein one or both of the first straight section and the second straight section comprise a plurality of nozzles.

17. A catalyst regenerator vessel for combusting carbonaceous deposits from catalyst comprising:
a combustion gas distributor in fluid communication with a combustion gas line for introducing a combustion gas to said vessel;
a catalyst pipe with a first opening and a second opening, said catalyst pipe feeding a catalyst distributor being attached to said catalyst pipe, the catalyst distributor comprising:
a first header in fluid communication with said first opening in said catalyst pipe for distributing catalyst to said vessel, an angular nozzle in said first header projecting at an angle to a longitudinal axis of said first header for distributing catalyst into said vessel;
a separator in communication with said regenerator vessel for separating gas from said catalyst; and
a regenerated catalyst outlet for discharging regenerated catalyst from said vessel.

18. The catalyst regenerator vessel of claim 17 wherein said catalyst distributor comprises a second header and an angular nozzle in said second header projecting at an angle to a longitudinal axis of said second header for distributing catalyst into said vessel.

19. The catalyst regenerator vessel of claim 17 wherein said first header includes a series of angular nozzles on a side of said header each projecting at an angle from said longitudinal axis of said header for distributing catalyst into said vessel, an angle with said longitudinal axis of each angular nozzle in the series decreases for each angular nozzle the farther said angular nozzle is from said first opening.

20. A process for combusting coke from catalyst comprising:
delivering coked catalyst from a catalyst pipe to a catalyst distributor, said catalyst distributor comprising:
a first header in fluid communication with a first opening in said catalyst pipe for distributing catalyst to said vessel, an angular nozzle in said first header projecting at an angle to a longitudinal axis of said first header for distributing catalyst into said vessel;
discharging catalyst from said catalyst distributor from at least two sides of said catalyst pipe into a regenerator vessel;
delivering combustion gas to said regenerator vessel for combusting coke from said catalyst to produce flue gas and regenerated catalyst;
separating said flue gas from said regenerated catalyst; and
discharging regenerated catalyst from said regenerator vessel.
